(19) United States
(12) Patent Application Publication
(10) Pub. No.: US 2014/0337022 A1
(43) Pub. Date: Nov. 13, 2014

(54) SYSTEM AND METHOD FOR LOAD BALANCING IN A SPEECH RECOGNITION SYSTEM

(71) Applicant: Tencent Technology (Shenzhen) Company Limited, Shenzhen (CN)

(72) Inventor: Qiuge LIU, Shenzhen (CN)

(73) Assignee: Tencent Technology (Shenzhen) Company Limited, Shenzhen (CN)

(21) Appl. No.: 14/257,941

(22) Filed: Apr. 21, 2014

Related U.S. Application Data
(63) Continuation of application No. PCT/CN2013/087998, filed on Nov. 28, 2013.

(30) Foreign Application Priority Data
Feb. 1, 2013 (CN) 201310040812.4

(51) Int. Cl. G10L 15/01

(52) U.S. Cl. CPC G10L 15/01
USPC 704/231

(57) ABSTRACT

The various implementations described herein include systems, methods and/or devices used to enable load balancing in a speech recognition system. For example, in some implementations, the method includes, at a speech access server: (1) initializing the speech access server, (2) receiving a speech request from a terminal, (3) determining, in accordance with a predefined load balancing algorithm, a first speech recognition server to process the speech request, (4) determining whether the first speech recognition server is available for processing, (5) if the first speech recognition server is available, forwarding the speech request to the first speech recognition server for processing, and (6) if the first speech recognition server is not available: (a) determining whether other speech recognition servers are available for processing, and (b) if a second speech recognition server is available, forwarding the speech request to the second speech recognition server for processing.

### RELATED APPLICATIONS

This application is a continuation application of PCT Patent Application No. PCT/CN2013/087998, entitled “SYSTEM AND METHOD FOR LOAD BALANCING IN A SPEECH RECOGNITION SYSTEM” filed Nov. 28, 2013, which claims priority to Chinese Patent Application No. 201310040812.4, “Method and Device for Realizing Load Balancing in a Speech Recognition System,” filed Feb. 1, 2013, both of which are hereby incorporated by reference in their entirety.

### FIELD OF THE INVENTION

The disclosed embodiments relate generally to speech recognition technology, and in particular, to a system and method for load balancing in a speech recognition system.

### BACKGROUND OF THE INVENTION

Speech recognition technology refers to a technology that makes the machine transform the speech signals into corresponding texts or commands through recognition and understanding, that is to say, to make the machine understand human speech.

FIG. 1 is a block diagram illustrating a speech recognition system, in accordance with some embodiments. As is shown in FIG. 1, including: terminal 110 and server cluster 120, wherein the server cluster 120 can also include speech access server(s) 122 and speech recognition server(s) 124; the terminal 110 can be a fixed terminal or a mobile terminal, generally with more than one terminal; the number of speech access servers can be one or more; and the number of speech recognition servers is generally more than one.

Among which, the speech access server 122 is responsible for forwarding speech requests sent by the terminal 110 to speech recognition server 124, and the speech recognition server 124 is responsible for processing the received speech, such as speech recognition and so on.

As mentioned above, the number of speech recognition servers is generally more than one, maybe dozens or even hundreds, so it is necessary for the speech access server 122 to forward the received speech requests to each of the speech recognition servers in a distributed manner to balance the load of multiple speech requests.

In the conventional technologies, the following load balancing method is generally adopted: Domain Name System (DNS) polling method, i.e. conducting the DNS polling by setting various records for the domain name, to realize the load balancing between the speech recognition servers.

However, several problems may exist in the actual application of the DNS method. For example, when the speech access server determines with certainty that one of the received requests is necessary to forward to one of the speech recognition servers to process, it will forward the request to the speech recognition server, regardless of its status, that is to say, regardless of whether it can be used or not, which may cause processing failure (i.e., reducing the success rate of speech request processing).

### SUMMARY

Various implementations of systems, methods and devices within the scope of the appended claims each have several aspects, no single one of which is solely responsible for the attributes described herein. Without limiting the scope of the appended claims, after considering this disclosure, and particularly after considering the section entitled “Detailed Description” one will understand how the aspects of various implementations are used to enable a system and method for load balancing in a speech recognition system. Some implementations include a method of load balancing in a speech recognition system. In some implementations, the method includes, at a speech access server having one or more processors and memory storing one or more programs configured for execution by the one or more processors, (1) initializing the speech access server, including establishing one or more Transmission Control Protocol (TCP) long connections with each speech recognition server of a plurality of speech recognition servers, (2) receiving a speech request from a terminal, (3) determining, in accordance with a predefined load balancing algorithm, a first speech recognition server of the plurality of speech recognition servers to process the speech request, (4) determining whether the first speech recognition server is available for processing, (5) in accordance with a determination that the first speech recognition server is available, forwarding the speech request to the first speech recognition server for processing, and (6) in accordance with a determination that the first speech recognition server is not available: (a) determining, in succession, whether other speech recognition servers of the plurality of speech recognition servers are available for processing, and (b) in accordance with a determination that a second speech recognition server is available, forwarding the speech request to the second speech recognition server for processing.

### BRIEF DESCRIPTION OF THE DRAWINGS

So that the present disclosure can be understood in greater detail, a more particular description may be had by reference to the features of various implementations, some of which are illustrated in the appended drawings. The appended drawings, however, merely illustrate the more pertinent features of the present disclosure and are therefore not to be considered limiting, for the description may admit to other effective features.

FIG. 1 is a block diagram illustrating a speech recognition system, in accordance with some embodiments.

FIG. 2 is a flowchart diagram of a method for load balancing in a speech recognition system, in accordance with some embodiments.

FIG. 3 is a flowchart diagram of a method for load balancing in a speech recognition system, in accordance with some embodiments.

FIG. 4 is a block diagram illustrating an implementation of a speech access server, in accordance with some embodiments.

FIGS. 5A-5D illustrate a flowchart representation of a method of load balancing in a speech recognition system, in accordance with some embodiments.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

Reference will now be made in detail to embodiments, examples of which are illustrated in the accompanying drawings. In the following detailed description, numerous specific details are set forth in order to provide a thorough understanding of the subject matter presented herein. But it will be apparent to one skilled in the art that the subject matter may be practiced without these specific details. In other instances, well-known methods, procedures, components, and circuits have not been described in detail so as not to unnecessarily obscure aspects of the embodiments.

Aiming at the problems existing in the conventional technology, the present application proposes a realization method for load balancing in a speech recognition system, which can increase the success rate of speech request processing.

In order to make the technical scheme of the present application clearer and more perspicuous, in the following, referring to the attached drawings and making embodiment to further explain the mentioned scheme of this invention in detail.

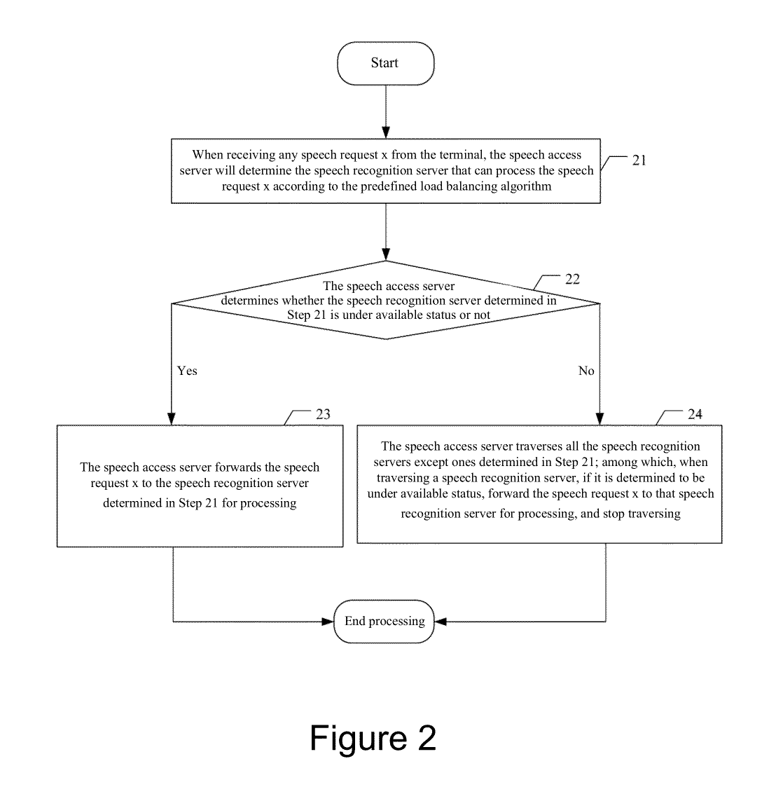

FIG. 2 is a flowchart diagram of a method for load balancing in a speech recognition system, in accordance with some embodiments. As shown in FIG. 2, including:

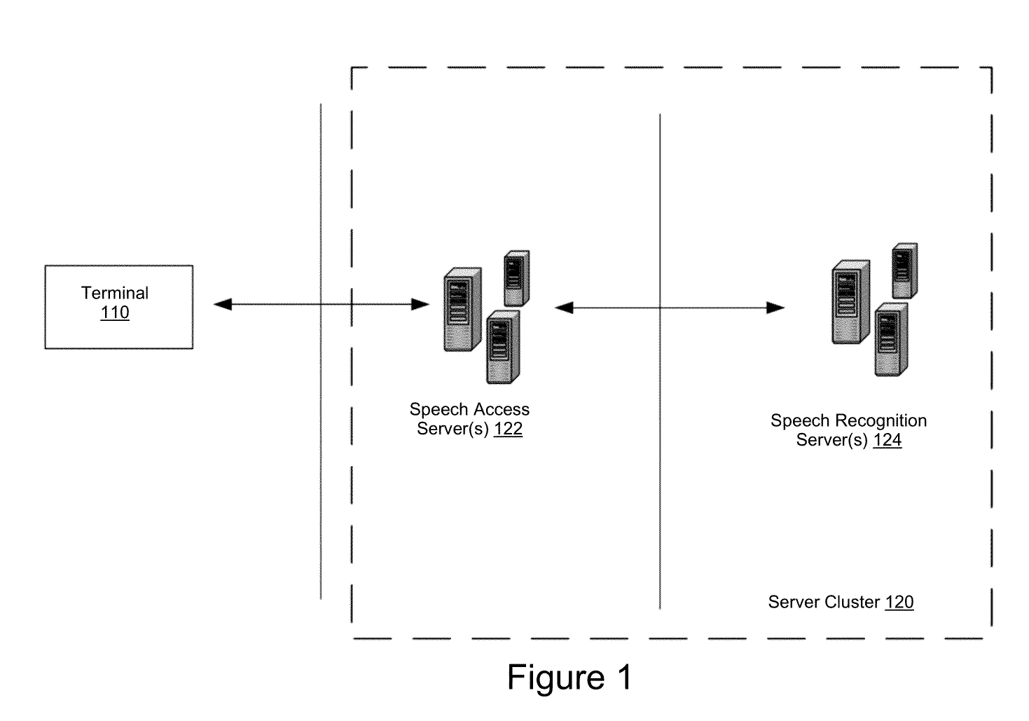

Step 21: when receiving any speech request x from the terminal (e.g., terminal 110, FIG. 1), the speech access server will determine the speech recognition server that can process the speech request x according to the predefined load balancing algorithm.

In some embodiments, for ease of description, the speech request x is used to represent any speech request received by the speech access server.

The terminal conducts information interaction with speech access server by the established Transmission Control Protocol (TCP) long connection or TCP short connection with speech access server.

The speech access server can allot a unique number with value between 0 and N-1 to each speech recognition server in advance, and the value of N equals the total number of speech recognition servers.

In this way, when receiving the speech request x, the speech access server can firstly obtain the carried voice ID, and conduct Hash operation to the voice ID to get a Hash value; after that, conduct the modulo operation for the obtained Hash value and N, determine the speech recognition server whose number equals to the result of modulo operation as the speech recognition server which can process the speech request x.

The concrete realization mode of mentioned Hash operation is not limited, it is only required for the speech access server to use the same kind of Hash operation mode for each received speech request.

For example:

Suppose the value of N is 100, that is, the total number of speech recognition servers is 100, and suppose the Hash value of the voice ID carried by speech request x is 1043;

It can be obtained by the modulo operation: 1043%100=43, that is, the result of modulo operation is 43, then, it is determined to be necessary to forward the speech request x to the speech recognition server with number of 43 for processing.

Step 22: speech access server determines whether the speech recognition server determined in Step 21 is under available status or not, if yes, conduct Step 23, otherwise, conduct Step 24.

If a certain speech recognition server is down, it can be considered to be under unavailable status.

Step 23: the speech access server forwards the speech request x to the speech recognition server determined in Step 21 for processing, end the process.

In the actual application, when the speech access server is initialized, it can establish M pieces of TCP long connections with each speech recognition server respectively, and M is a positive integer.

In this way, when it is necessary for the speech access server to forward a certain speech request to a certain speech recognition server, the established TCP long connection(s) can be used directly, that is, the information can be directly interacted with the speech recognition server by the aforementioned TCP long connection(s), which saves the establishing time of TCP long connection(s) when needed.

The number of TCP long connections established between speech access server and each speech recognition server, that is, the concrete value of M, shall be determined according to the actual necessity, which can be one or multiple. The advantage of multiple TCP long connections is that when the speech access server receives multiple speech requests at the same time and judges that the multiple speech requests shall all be processed by the same speech recognition server, then the multiple TCP long connections can be used to forward the multiple speech requests to the speech recognition sever respectively, which increases the transmission efficiency. If there is only one TCP long connection, the speech request can only be forwarded one by one.

Step 24: the speech access server traverses all the speech recognition servers except ones determined in Step 21; among which, when traversing a speech recognition server, if it is determined to be under available status, forward the speech request x to that speech recognition server for processing, and stop traversing and end the process.

For example:

Suppose the value of N is 100 (i.e., the total number of speech recognition servers is 100), and suppose the number of speech recognition server determined in Step 21 is 43. Then, if speech recognition server 43 is under unavailable status, then speech recognition server 44, speech recognition server 45, speech recognition server 46, and so on, are traversed in order.

If it can be determined to be under available status when traversing to speech recognition server 45, then, forward the speech request x to speech recognition server 45 for processing and stop traversing.

If each traversed speech recognition server is under unavailable status, then return the processing failure information to the terminal.

Besides, in the actual application, in Step 23 and Step 24, the following processing can also be conducted when the speech access server forwards speech request x to a certain speech recognition server for processing:

1) determine whether the speech recognition server processes speech request x successfully;

2) if yes, return the processing success message to the terminal;

3) if no, determine whether the speech recognition server is under available status or not again; if no, return the processing failure message to terminal; if yes, then forward the speech request x to the speech recognition server again for processing, and determine again whether the speech recognition server can process speech request x successfully; if yes, return the processing success message to terminal; if no, return the processing failure message to terminal.

Although it has already been determined whether the speech recognition server is under available status or not before forwarding speech request x to the speech recognition server for processing, and only when it has been determined to be under available status will the speech request x be forwarded to the speech recognition server, there still may be unexpected conditions (e.g., the speech recognition server is down and being under unavailable status just after receiving speech request x but not processing), which causes unsuccessful processing of speech request x, or maybe because of other reasons to cause unsuccessful processing of speech request x. Therefore, after determining that the speech recognition server does not process speech request x successfully in Step 1), then Step 3) can be conducted.

The speech access server can record the unavailable speech recognition servers for convenience of repairing in time.

Further, for the recorded unavailable speech recognition server, when the speech access server determines that it is necessary to forward a certain speech request to the speech recognition server, it can traverse other speech recognition servers directly, and the speech access server can periodically check whether the recorded unavailable speech recognition server recovers available status and the recovered speech recognition server can process speech requests again.

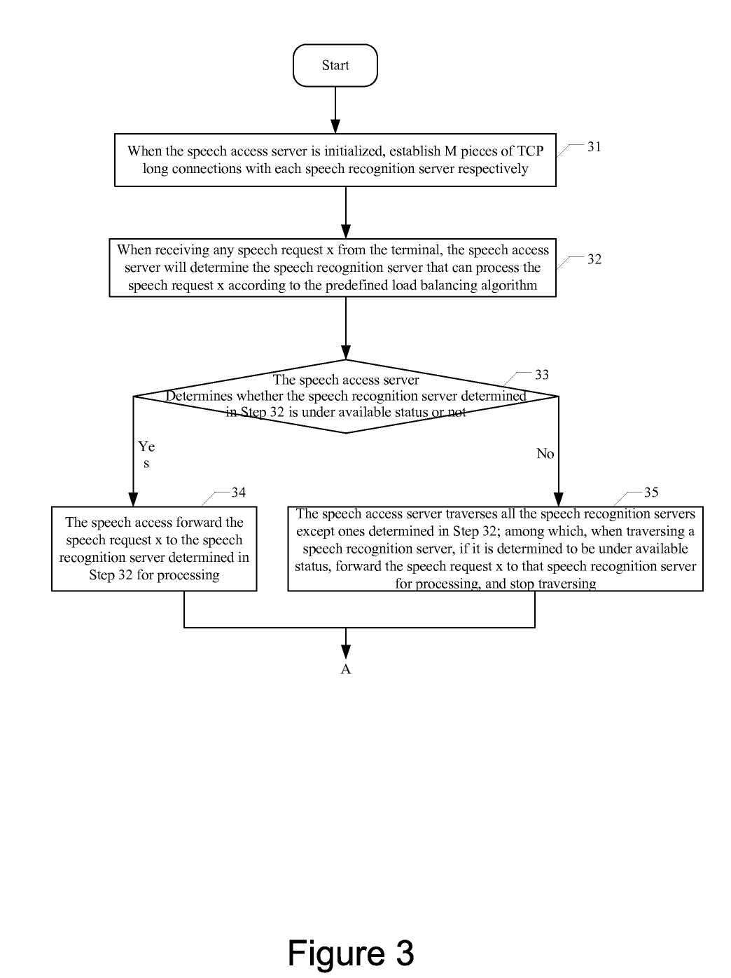

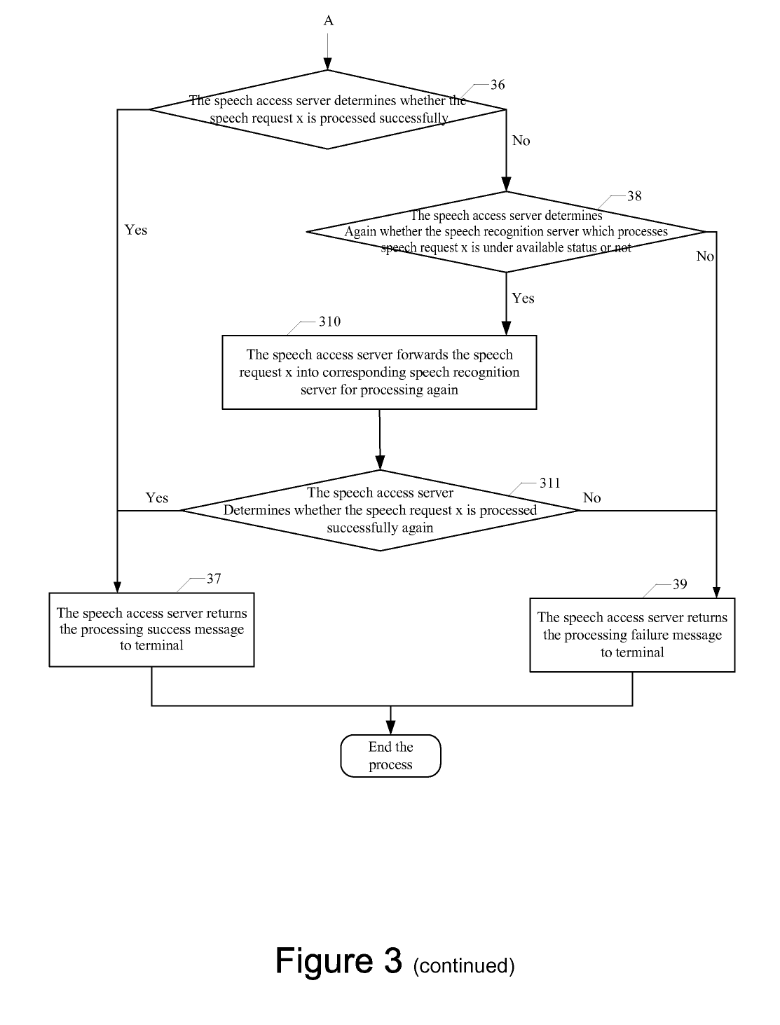

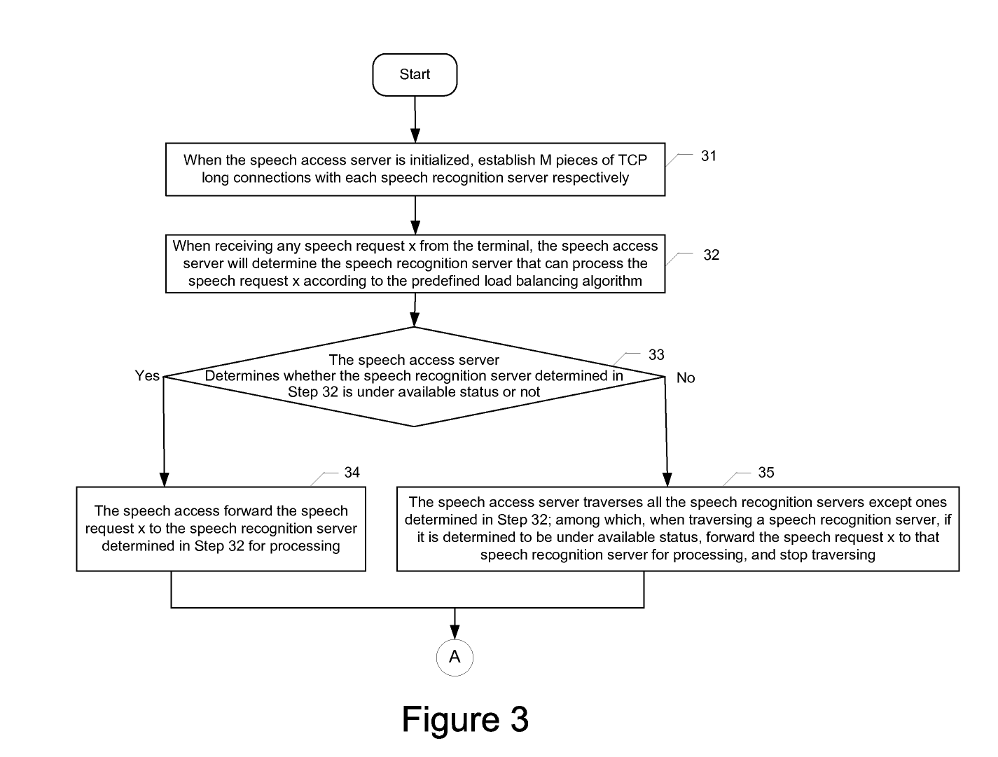

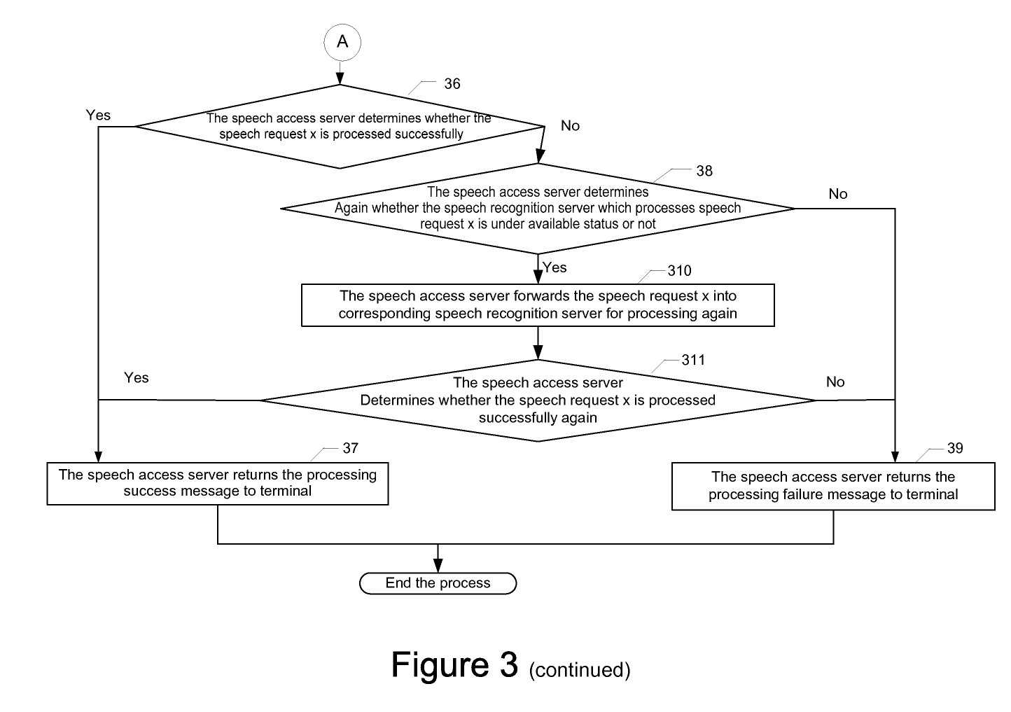

FIG. 3 is a flowchart diagram of a method for load balancing in a speech recognition system, in accordance with some embodiments. As shown in FIG. 3, including:

Step 31: when the speech access server is initialized, establish M pieces of TCP long connections with each speech recognition server respectively.

Step 32: when receiving any speech request x from the terminal (e.g., terminal 110, FIG. 1), the speech access server will determine the speech recognition server that can process the speech request x according to the predefined load balancing algorithm.

Step 33: the speech access server determines whether the speech recognition server determined in Step 32 is under available status or not, if yes, conduct Step 34, otherwise, conduct Step 35.

Step 34: the speech access server forwards the speech request x to the speech recognition server determined in Step 32 for processing, then conduct Step 36.

Step 35: the speech access server traverses all the speech recognition servers except ones determined in Step 32; among which, when traversing a speech recognition server, if it is determined to be under available status, forward the speech request x to that speech recognition server for processing, and stop traversing, then conduct Step 36.

Step 36: the speech access server determines whether the speech request x is processed successfully, if yes, conduct Step 37, otherwise, conduct Step 38.

Step 37: the speech access server returns the processing success message to terminal and end the process.

Step 38: the speech access server determines whether the speech recognition server which can process the speech request x is under available status or not again; if no, conduct Step 39, if yes, conduct Step 310.

Step 39: the speech access server returns the processing failure message to terminal and end the process.

Step 310: the speech access server forwards the speech request x to the corresponding speech recognition server for processing again.

Step 311: the speech access server determines whether the speech request x is processed successfully again, if yes, conduct Step 37, otherwise, conduct Step 39.

The disclosed embodiments include a speech access server, which includes, in some embodiments, a load balancing module. In some embodiments, the load balancing module includes: receiver unit and forward unit.

Receiver unit, configured to receive any speech request sent by the terminal (e.g., terminal 110, FIG. 1) and forward the speech request to the forward unit;

Forward unit, configured to determine the speech recognition server which can process the speech request according to predefined load balancing algorithm; and determine whether the speech recognition server is under available status or not; if yes, forward the speech request to the speech recognition server for processing; if no, traverse each of the other speech recognition servers except that one; further, when traversing a speech recognition server, if it can be determined to be under available status, forward the speech request to the speech recognition server for processing and stop traversing.

Further, the forward unit can be used to allot a unique number with values between 0 and N-1 to each speech recognition server in advance, and the value of N equals the total number of speech recognition servers.

In some implementations, the forward unit obtains the voice ID carried by the speech request, and conducts Hash operation to the voice ID to get a Hash value; then conducts the modulo operation for the obtained Hash value and N, determines the speech recognition server whose number equals the result of the modulo operation as the speech recognition server which can process the speech request.

The forward unit can be further used to return the processing failure message to the terminal if each traversed speech recognition server is under unavailable status.

The forward unit can be further used to determine whether the speech recognition server can process the speech request successfully after forwarding a speech request to a speech recognition server for processing; if yes, return the processing success message to terminal; if no, determine whether the speech recognition is under available status or not; if no, return processing failure message to terminal, if yes, forward the speech request to the speech recognition server again for processing and determine again whether the speech recognition server can process the speech request successfully, if yes, return the processing success message to terminal, if no, return the processing failure message to terminal.

The forward unit can be further used to establish M pieces of TCP long connections with each speech recognition server respectively when the speech access server is initialized, then the information interaction with each speech recognition server can be conducted through the mentioned TCP long connection(s), where M is a positive integer.

It should be noted that, in the actual application, in addition to the load balancing module, the speech access server also includes some other components generally, but because there is no direct relation with the mentioned program of the present application, they will not be introduced here.

Further, please refer to the corresponding instruction in the embodiment of the aforementioned method for specific operating process of the above mentioned speech access server, which will not be repeated here.

In summary, before forwarding a certain speech request to a certain speech recognition server for processing, it is determined whether the speech recognition server is under available status or not; if yes, forward it, if no, forward it to the other available speech recognition servers instead of to this one, which can increase the success rate of speech request processing and avoid large-scale processing failure, without oscillating effect.

Further, in the speech recognition system, a stream transmission mode is adopted between a terminal (e.g., terminal 110, FIG. 1) and a server cluster (e.g., server cluster 120, FIG. 1). In the stream transmission mode, the transmission and recognition of a speech information is not completed by a single speech request. Rather, the speech information is segmented into a series of speech requests according to certain rules, such as segment into four speech requests and send to the server cluster according to the preset order respectively. The server cluster will distinguish the different speech information according to the difference of voice ID. The voice ID of each speech information is unique. For the different speech requests of the same speech information, they shall be forwarded to the same speech recognition server for processing to realize the conversation maintenance; it can be seen that, after adopting the mentioned program of the present application, because the voice ID carried by different speech requests of the same speech information is the same, after Hash operation and modulo operation, these different requests of the same speech information will all be forwarded to the same speech recognition server for processing.

The various implementations described herein include systems, methods and/or devices used to enable load balancing in a speech recognition system. Some implementations include systems, methods and/or devices to process speech requests in accordance with a load balancing algorithm.

More specifically, some implementations include a method of load balancing in a speech recognition system. In some implementations, the method includes, at a speech access server having one or more processors and memory storing one or more programs configured for execution by the one or more processors, (1) initializing the speech access server, including establishing one or more Transmission Control Protocol (TCP) long connections with each speech recognition server of a plurality of speech recognition servers, (2) receiving a speech request from a terminal, (3) determining, in accordance with a predefined load balancing algorithm, a first speech recognition server of the plurality of speech recognition servers to process the speech request, (4) determining whether the first speech recognition server is available for processing, (5) in accordance with a determination that the first speech recognition server is available, forwarding the speech request to the first speech recognition server for processing, and (6) in accordance with a determination that the first speech recognition server is not available: (a) determining, in succession, whether other speech recognition servers of the plurality of speech recognition servers are available for processing, and (b) in accordance with a determination that a second speech recognition server is available, forwarding the speech request to the second speech recognition server for processing.

In some embodiments, determining, in accordance with the predefined load balancing algorithm, the first speech recognition server includes: (1) obtaining a voice ID from the speech request, (2) generating a hash value based on the voice ID, (3) assigning a unique number to each speech recognition server of the plurality of speech recognition servers, wherein the plurality of speech recognition servers includes N speech recognition servers, (4) calculating a first value equal to the hash value modulo N, and (5) determining the first speech recognition server in accordance with a determination that the first value equals the unique number assigned to the first speech recognition server.

In some embodiments, the method further includes (1) determining whether the speech request was processed successfully by a respective speech recognition server, (2) in accordance with a determination that the speech request was processed successfully, returning a first message to the terminal, and (3) in accordance with a determination that the speech request was not processed successfully: (a) determining whether the respective speech recognition server is available for processing, (b) in accordance with a determination that the respective speech recognition server is available: (i) forwarding the speech request to the respective speech recognition server for processing, (ii) determining whether the speech request was processed successfully by the respective speech recognition server, (iii) in accordance with a determination that the speech request was processed successfully, returning the first message to the terminal, and (iv) in accordance with a determination that the speech request was not processed successfully, returning a second message to the terminal, and (c) in accordance with a determination that the respective speech recognition server is not available, returning the second message to the terminal.

In some embodiments, the speech request is one of a plurality of speech requests associated with a speech information stream.

In some embodiments, the plurality of speech requests associated with the speech information stream are processed by the same speech recognition server of the plurality of speech recognition servers.

In some embodiments, the method further includes recording which speech recognition servers of the plurality of speech recognition servers were not available for processing.

In another aspect, any of the methods described above are performed by a computer system, the computer system including (1) one or more processors, (2) memory, and (3) one or more programs stored in the memory and configured for execution by the one or more processors, the one or more programs including instructions for any of the methods described above.

In yet another aspect, a non-transitory computer readable storage medium stores one or more programs for execution by one or more processors of a computer system, the one or more programs including instructions for causing the computer system to perform any of the methods described above.

Numerous details are described herein in order to provide a thorough understanding of the example implementations illustrated in the accompanying drawings. However, some embodiments may be practiced without many of the specific details, and the scope of the claims is only limited by those features and aspects specifically recited in the claims. Furthermore, well-known methods, components, and circuits have not been described in exhaustive detail so as not to unnecessarily obscure more pertinent aspects of the implementations described herein.

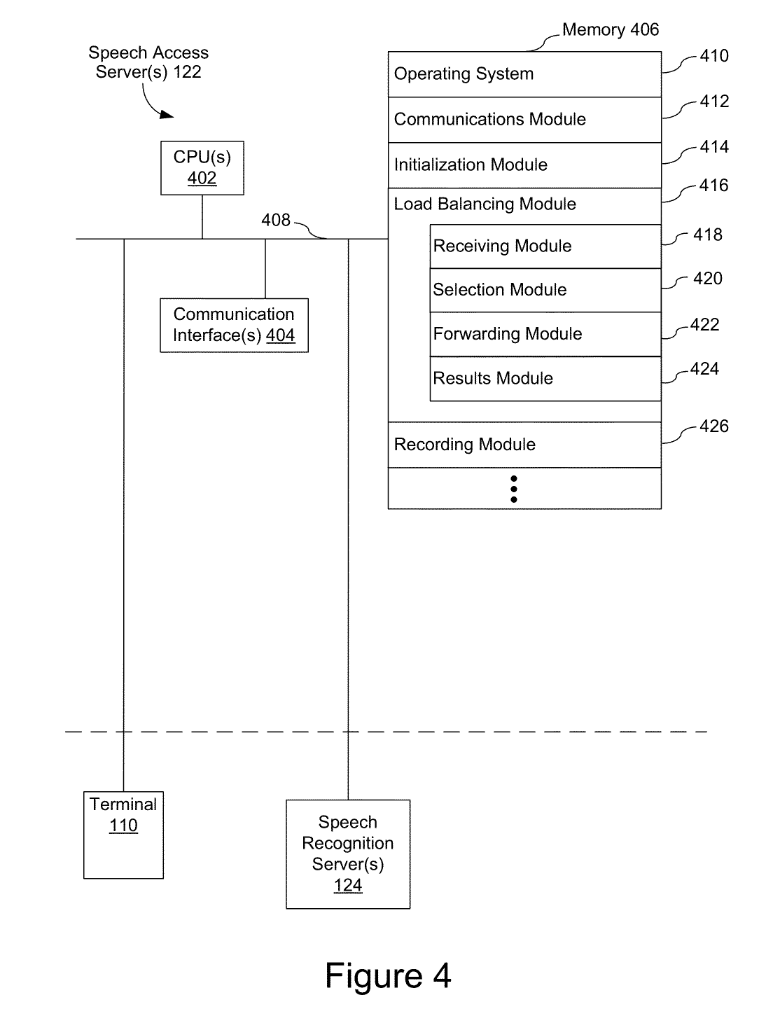

FIG. 4 is a block diagram illustrating an implementation of a speech access server 122, in accordance with some embodiments. Speech access server 122 typically includes one or more processing units (CPUs) 402 for executing modules, programs and/or instructions stored in memory 406 and thereby performing processing operations, memory 406, and one or more communication buses 408 for interconnecting these components. Communication buses 408 optionally include circuitry (sometimes called a chipset) that interconnects and controls communications between system components. Speech access server 122 is coupled to terminal 110 and speech recognition server(s) 124 by communication buses 408. Memory 406 includes high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. Memory 406 optionally includes one or more storage devices remotely located from the CPU(s) 402. Memory 406, or alternately the non-volatile memory device(s) within memory 406, comprises a non-transitory computer readable storage medium. In some embodiments, memory 406, or the computer readable storage medium of memory 406 stores the following programs, modules, and data structures, or a subset thereof:
an operating system 410 that includes procedures for handling various basic system services and for performing hardware dependent tasks;
a communications module 412 that is used for connecting the speech access server 122 to a terminal (e.g., terminal 110) or other servers (e.g., speech recognition server(s) 124) via one or more communication networks (wired or wireless), such as the Internet, other wide area networks, local area networks, metropolitan area networks, and so on;
an initialization module 414 that is used for initializing the speech access server 122, including establishing one or more connections (e.g., one or more Transmission Control Protocol (TCP) long connections) with other servers (e.g., speech recognition server(s) 124);
a load balancing module 416 that is used for load balancing speech requests in a speech recognition system (e.g., server cluster 120, FIG. 1); and
a recording module 426 that is used for recording which speech recognition servers were not available for processing.

In some embodiments, the load balancing module 416 optionally includes the following modules or sub-modules, or a subset thereof:
a receiving module 418 that is used for receiving a speech request from a terminal (e.g., terminal 110);
a selection module 420 that is used for selecting a speech recognition server (e.g., one of the speech recognition server(s) 124) to process the speech request;
a forwarding module 422 that is used for forwarding the speech request to an available speech recognition server; and
a results module 424 that is used for determining whether the speech request was processed successfully and returning a message to the terminal indicating the result of processing the speech request (e.g., whether the speech request was processed successfully or not).

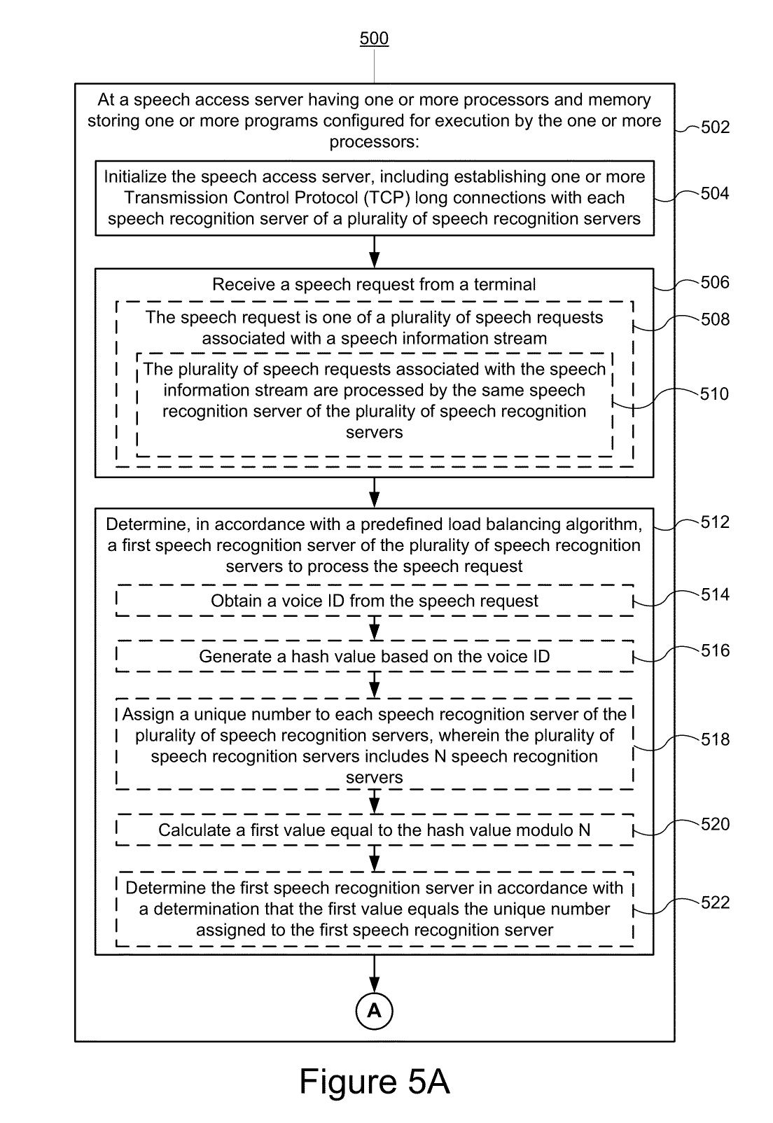

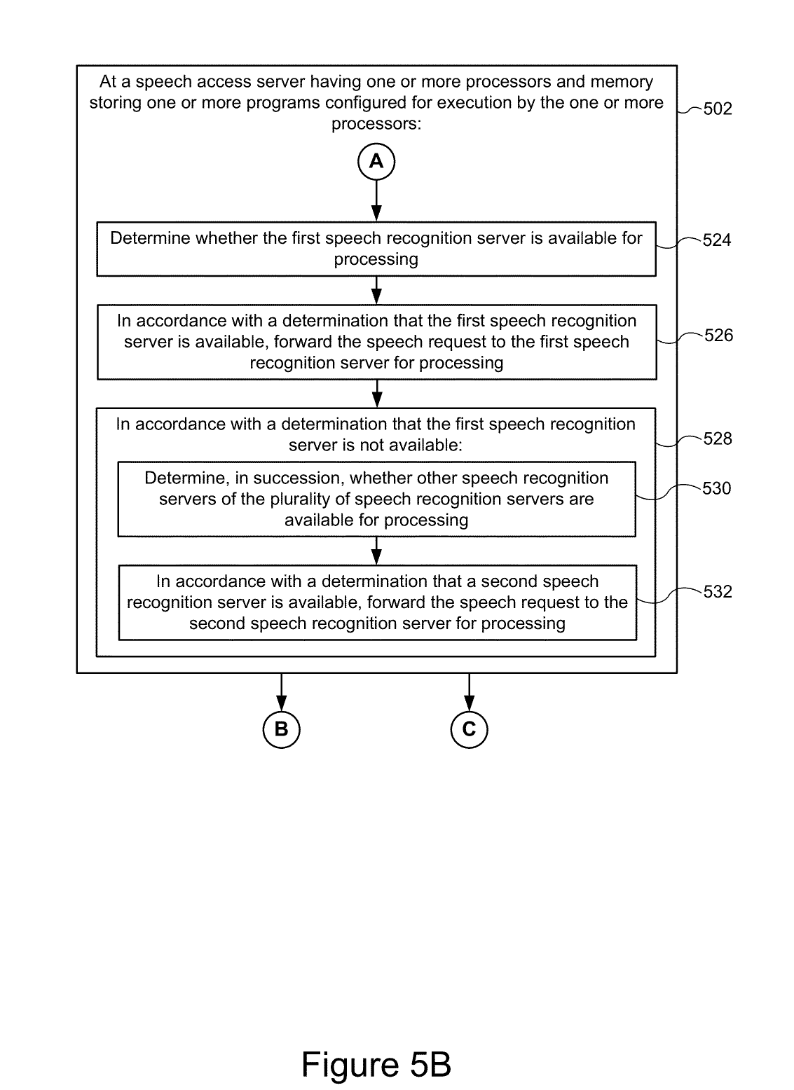

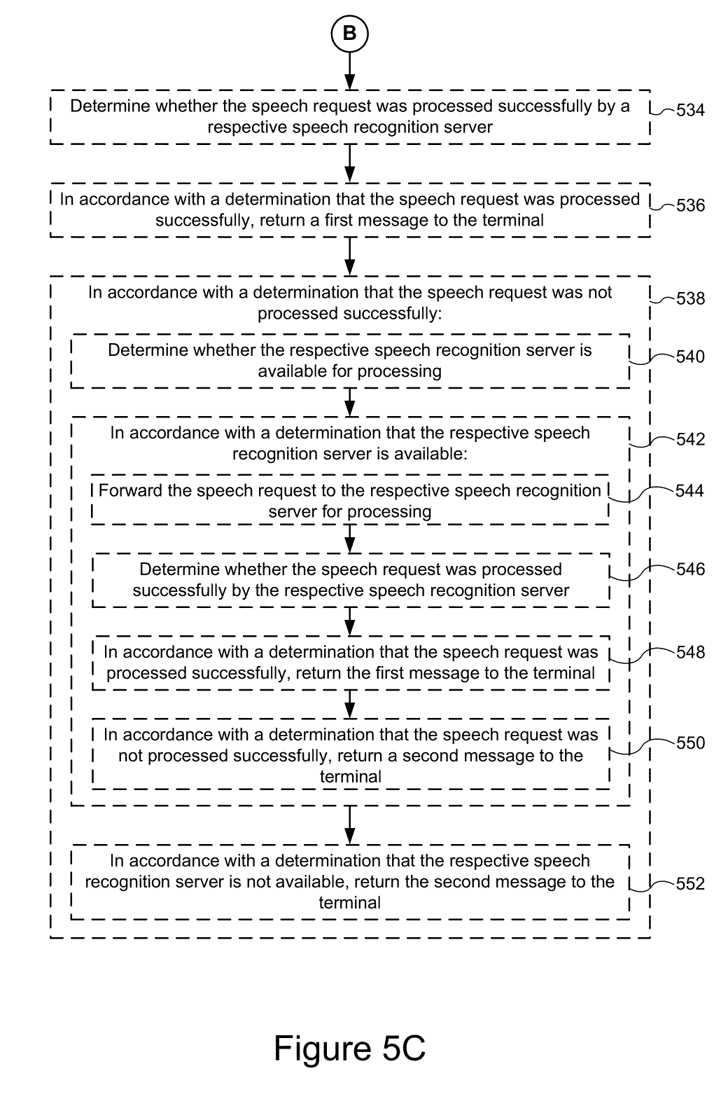

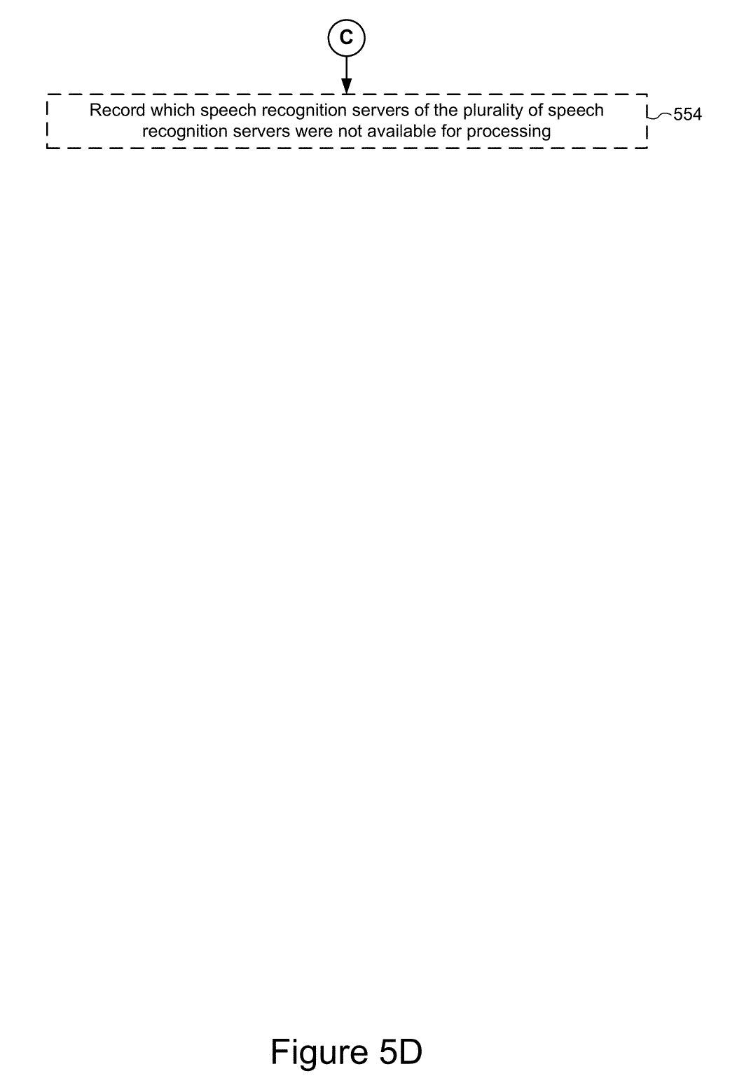

Each of the above identified elements may be stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 406 may store a subset of the modules and data structures identified above. Furthermore, memory 406 may store additional modules and data structures not described above. In some embodiments, the programs, modules, and data structures stored in memory 406, or the computer readable storage medium of memory 406, provide instructions for implementing any of the methods described below with reference to FIGS. 5A-5D.

Although FIG. 2 shows a speech access server 122, FIG. 2 is intended more as functional description of the various features which may be present in a speech access server than as a structural schematic of the embodiments described herein. In practice, and as recognized by those of ordinary skill in the art, items shown separately could be combined and some items could be separated.

FIGS. 5A-5D illustrate a flowchart representation of a method 500 of load balancing in a speech recognition system, in accordance with some embodiments. In some embodiments, method 500 is performed by a speech access server (e.g., speech access server 122, FIGS. 1 and 4) to load balance speech requests in a speech recognition system (e.g., server cluster 120, FIG. 1) received from a terminal (e.g., terminal 110, FIGS. 1 and 4). In some embodiments, method 500 is governed by instructions that are stored in a non-transitory computer readable storage medium and that are executed by one or more processors of a device, such as the one or more processing units (CPUs) 402 of speech access server 122, shown in FIG. 4.

A speech access server (e.g., speech access server 122, FIGS. 1 and 4) having (502) one or more processors and memory storing one or more programs configured for execution by the one or more processors initializes (504) the speech access server, including establishing one or more Transmission Control Protocol (TCP) long connections with each speech recognition server of a plurality of speech recognition servers (e.g., speech recognition server(s) 124, FIGS. 1 and 4). For example, for a first speech recognition server of the plurality of speech recognition servers, the speech access server may establish one TCP long connection with the first speech recognition server, and for a second speech recognition server of the plurality of speech recognition servers, the speech access server may establish three TCP long connections with the second speech recognition server. In some implementations, an initialization module (e.g., initialization module 414, FIG. 4) is used to initialize the speech access server, including establishing one or more TCP long connections with each speech recognition server of a plurality of speech recognition servers, as described above with respect to FIG. 4.

Next, the speech access server receives (506) a speech request from a terminal (e.g., terminal 110, FIGS. 1 and 4). In some implementations, a receiving module (e.g., receiving module 418, FIG. 4) is used for receiving a speech request from a terminal, as described above with respect to FIG. 4.

In some embodiments, the speech request is (508) one of a plurality of speech requests associated with a speech information stream. In some embodiments, a speech information stream is segmented into two or more speech requests and the two or more speech requests are sent in a predefined order by a terminal (e.g., terminal 110, FIGS. 1 and 4) to the speech recognition system (e.g., server cluster 120, FIG. 1). For example, if a speech information stream is segmented into four speech requests, the four speech requests are sent to the speech recognition system in a predefined order (e.g., speech request 1, speech request 2, speech request 3, and speech request 4).

In some embodiments, the plurality of speech requests associated with the speech information stream are (510) processed by the same speech recognition server of the plurality of speech recognition servers. Using the example above where a speech information stream is segmented into four speech requests, all four speech requests (e.g., speech request 1, speech request 2, speech request 3, and speech request 4) are processed by the same speech recognition server of the plurality of speech recognition servers. In some embodiments, speech requests from the same speech information stream have the same voice ID, which is used for determining a speech recognition server of the plurality of speech recognition servers to process the speech request, as discussed below with reference to operations 512-522.

Next, the speech access server determines (512), in accordance with a predefined load balancing algorithm, a first speech recognition server of the plurality of speech recognition servers (e.g., speech recognition server(s) 124, FIGS. 1 and 4) to process the speech request. In some implementations, a selection module (e.g., selection module 420, FIG. 4) is used to determine, in accordance with a predefined load balancing algorithm, a first speech recognition server of the plurality of speech recognition servers to process the speech request, as described above with respect to FIG. 4.

In some embodiments, determining (512), in accordance with the predefined load balancing algorithm, the first speech recognition server includes obtaining (514) a voice ID from the speech request. As discussed above, a speech information stream may be segmented into smaller speech requests. In some embodiments, different speech information streams have different voice IDs. Thus, speech requests from different speech information streams have different voice IDs and speech requests from the same speech information stream have the same voice ID, as discussed above with respect to operation 510. In some implementations, a selection module (e.g., selection module 420, FIG. 4) is used to obtain a voice ID from the speech request, as described above with respect to FIG. 4.

Next, determining (512) the first speech recognition server includes generating (516) a hash value based on the voice ID. In some embodiments, a hash function is an algorithm that maps data of variable length to data of a fixed length, and a hash value is the value returned by the hash function. For example, given a voice ID, the hash value based on the voice ID may be a four digit number (e.g., 1043). In some implementations, a selection module (e.g., selection module 420, FIG. 4) is used to generate a hash value based on the voice ID, as described above with respect to FIG. 4.

Further, determining (512) the first speech recognition server includes assigning (518) a unique number to each speech recognition server of the plurality of speech recognition servers, wherein the plurality of speech recognition servers includes N speech recognition servers. In some embodiments, for N speech recognition servers, the speech access server assigns a unique number between 0 and N-1 to each speech recognition server. For example, if there are 100 speech recognition servers, the speech access server assigns a unique number between 0 and 99 to each speech recognition server (e.g., 0, 1, 2, 3, . . . 97, 98, 99). In some implementations, a selection module (e.g., selection module 420, FIG. 4) is used to assign a unique number to each speech recognition server of the plurality of speech recognition servers, wherein the plurality of speech recognition servers includes N speech recognition servers, as described above with respect to FIG. 4.

Next, determining (512) the first speech recognition server includes calculating (520) a first value equal to the hash value modulo N. Using the examples above where the hash value based on the voice ID is 1043 and N is 100, a first value equal to the hash value modulo N is equal to 1043 mod 100, which is equal to 43. In some implementations, a selection module (e.g., selection module 420, FIG. 4) is used to calculate a first value equal to the hash value modulo N, as described above with respect to FIG. 4.

Next, determining (512) the first speech recognition server includes determining (522) the first speech recognition server in accordance with a determination that the first value equals the unique number assigned to the first speech recognition server. For example, using the examples above where N is 100 and the first value is 43, the first speech recognition server is the speech recognition server that was assigned the unique number 43, as discussed with respect to operation 518. In some implementations, a selection module (e.g., selection module 420, FIG. 4) is used to determine the first speech recognition server in accordance with a determination that the first value equals the unique number assigned to the first speech recognition server, as described above with respect to FIG. 4.

Then, the speech access server determines (524) whether the first speech recognition server is available for processing. For example, if the first speech recognition server is determined to be speech recognition server 43, the speech access server determines whether speech recognition server 43 is available for processing. In some implementations, a forwarding module (e.g., forwarding module 422, FIG. 4) is used to determine whether the first speech recognition server is available for processing, as described above with respect to FIG. 4.

Next, the speech access server, in accordance with a determination that the first speech recognition server is available, forwards (526) the speech request to the first speech recognition server for processing. For example, if the first speech recognition server is speech recognition server 43, in accordance with a determination that speech recognition server 43 is available, the speech access server forwards the speech request to speech recognition server 43 for processing. In some implementations, a forwarding module (e.g., forwarding module 422, FIG. 4) is used to forward, in accordance with a determination that the first speech recognition server is available, the speech request to the first speech recognition server for processing, as described above with respect to FIG. 4.

Next, in accordance with a determination that the first speech recognition is not available (528), the speech access server determines (530), in succession, whether other speech recognition servers of the plurality of speech recognition servers are available for processing. For example, if the first speech recognition server is speech recognition server 43 and speech recognition server 43 is not available, the speech access server determines whether speech access server 44 is available, whether speech recognition server 45 is available, and so on. In some embodiments, a speech recognition server is not available if the speech recognition server is down. In some implementations, a forwarding module (e.g., forwarding module 422, FIG. 4) is used to determine, in succession, whether other speech recognition servers of the plurality of speech recognition servers are available for processing, as described above with respect to FIG. 4.

Then, in accordance with a determination that a second speech recognition server is available, the speech access server forwards (532) the speech request to the second speech recognition server for processing. For example, if it is determined in operation 530 that speech recognition server 44 is not available, but speech recognition server 45 is available, the speech access server forwards the speech request to speech recognition server 45 for processing. In some implementations, a forwarding module (e.g., forwarding module 422, FIG. 4) is used to forward, in accordance with a determination that a second speech recognition server is available, the speech request to the second speech recognition server for processing, as described above with respect to FIG. 4.

Optionally, in accordance with a determination that no speech recognition server is available for processing, the speech access server returns a message to the terminal indicating that the speech request was not successfully processed. In some implementations, a results module (e.g., results module 424, FIG. 4) is used to return, in accordance with a determination that no speech recognition server is available for processing, a message to the terminal indicating that the speech request was not successfully processed, as described above with respect to FIG. 4.

Optionally, the speech access server determines (534) whether the speech request was processed successfully by a respective speech recognition server. Although it was previously determined, as discussed above, that the respective speech recognition server was available for processing before the speech request was forwarded to the respective speech recognition server, unexpected conditions may still cause unsuccessful processing of the speech request (e.g., the respective speech recognition server going down and becoming unavailable just after receiving the speech request but before successfully processing the speech request). In some implementations, a results module (e.g., results module 424, FIG. 4) is used to determine whether the speech request was processed successfully by a respective speech recognition server, as described above with respect to FIG. 4.

Next, the speech access server, in accordance with a determination that the speech request was processed successfully, returns (536) a first message to the terminal (e.g., terminal 110, FIGS. 1 and 4). In some embodiments, the first message to the terminal includes a message indicating the speech request was processed successfully. In some implementations, a results module (e.g., results module 424, FIG. 4) is used to return, in accordance with a determination that the speech request was processed successfully, a first message to the terminal, as described above with respect to FIG. 4.

Further, the speech access server, in accordance with a determination that the speech request was not processed successfully (538), determines (540) whether the respective speech recognition server is available for processing. For example, if the respective speech recognition server is speech recognition server 43, the speech access server determines whether speech recognition server 43 is available for processing. In some implementations, a forwarding module (e.g., forwarding module 422, FIG. 4) is used to determine whether the respective speech recognition server is available for processing, as described above with respect to FIG. 4.

In accordance with a determination that the respective speech recognition server is available (542), the speech access server forwards (544) the speech request to the respective speech recognition server for processing. For example, if the respective speech recognition server is speech recognition server 43, in accordance with a determination that speech recognition server 43 is available, the speech access server forwards the speech request to speech recognition server 43 for processing. In some implementations, a forwarding module (e.g., forwarding module 422, FIG. 4) is used to forward, in accordance with a determination that the respective speech recognition server is available, the speech request to the respective speech recognition server for processing, as described above with respect to FIG. 4.

Next, the speech access server determines (546) whether the speech request was processed successfully by the respective speech recognition server. The speech access server determines whether the speech request was processed successfully the second time by the respective speech recognition server. In some implementations, a results module (e.g., results module 424, FIG. 4) is used to determine whether the speech request was processed successfully by the respective speech recognition server, as described above with respect to FIG. 4.

In accordance with a determination that the speech request was processed successfully, the speech access server returns (548) the first message to the terminal. In some embodiments, the first message to the terminal includes a message indicating the speech request was processed successfully. In some implementations, a results module (e.g., results module 424, FIG. 4) is used to return, in accordance with a determination that the speech request was processed successfully, the first message to the terminal, as described above with respect to FIG. 4.

In accordance with a determination that the speech request was not processed successfully, the speech access server returns (550) a second message to the terminal. In some embodiments, the second message to the terminal includes a message indicating the speech request was not processed successfully. In some implementations, a results module (e.g., results module 424, FIG. 4) is used to return, in accordance with a determination that the speech request was not processed successfully, a second message to the terminal, as described above with respect to FIG. 4.

Further, the speech access server, in accordance with a determination that the respective speech recognition server is not available, returns (552) the second message to the terminal. In some embodiments, the second message to the terminal includes a message indicating the speech request was not processed successfully. For example, if the respective speech recognition server is speech recognition server 43, in accordance with a determination that speech recognition server 43 is not available, the speech access server returns the second message, indicating the speech request was not processed successfully, to the terminal. In some implementations, a results module (e.g., results module 424, FIG. 4) is used to return, in accordance with a determination that the respective speech recognition server is not available, the second message to the terminal, as described above with respect to FIG. 4.

Optionally, the speech access server records (554) which speech recognition servers of the plurality of speech recognition servers (e.g., speech recognition server(s) 124, FIGS. 1 and 4) were not available for processing. In some embodiments, the speech recognition servers that were not available for processing are recorded for repairing at a later time. In some embodiments, the speech recognition servers that were not available for processing are recorded for reference by the speech access server so it can determine whether a particular speech recognition server is currently available for processing. In some implementations, a recording module (e.g., recording module 426, FIG. 4) is used to record which speech recognition servers of the plurality of speech recognition servers were not available for processing.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method of load balancing in a speech recognition system, the method comprising:
at a speech access server having one or more processors and memory storing one or more programs configured for execution by the one or more processors:
initializing the speech access server, including establishing one or more Transmission Control Protocol (TCP) long connections with each speech recognition server of a plurality of speech recognition servers;
receiving a speech request from a terminal;
determining, in accordance with a predefined load balancing algorithm, a first speech recognition server of the plurality of speech recognition servers to process the speech request;
determining whether the first speech recognition server is available for processing;
in accordance with a determination that the first speech recognition server is available, forwarding the speech request to the first speech recognition server for processing; and
in accordance with a determination that the first speech recognition server is not available:
determining, in succession, whether other speech recognition servers of the plurality of speech recognition servers are available for processing; and
in accordance with a determination that a second speech recognition server is available, forwarding the speech request to the second speech recognition server for processing.

2. The method of claim 1, wherein determining, in accordance with the predefined load balancing algorithm, the first speech recognition server includes:
obtaining a voice ID from the speech request;
generating a hash value based on the voice ID;
assigning a unique number to each speech recognition server of the plurality of speech recognition servers, wherein the plurality of speech recognition servers includes N speech recognition servers;
calculating a first value equal to the hash value modulo N; and
determining the first speech recognition server in accordance with a determination that the first value equals the unique number assigned to the first speech recognition server.

3. The method of claim 1, further comprising:
determining whether the speech request was processed successfully by a respective speech recognition server;
in accordance with a determination that the speech request was processed successfully, returning a first message to the terminal; and
in accordance with a determination that the speech request was not processed successfully:
determining whether the respective speech recognition server is available for processing;
in accordance with a determination that the respective speech recognition server is available:
forwarding the speech request to the respective speech recognition server for processing;
determining whether the speech request was processed successfully by the respective speech recognition server;
in accordance with a determination that the speech request was processed successfully, returning the first message to the terminal; and
in accordance with a determination that the speech request was not processed successfully, returning a second message to the terminal; and
in accordance with a determination that the respective speech recognition server is not available, returning the second message to the terminal.

4. The method of claim 1, wherein the speech request is one of a plurality of speech requests associated with a speech information stream.

5. The method of claim 4, wherein the plurality of speech requests associated with the speech information stream are processed by the same speech recognition server of the plurality of speech recognition servers.

6. The method of claim 1, further comprising recording which speech recognition servers of the plurality of speech recognition servers were not available for processing.

7. A computer system, comprising:
one or more processors;
memory; and
one or more programs stored in the memory and configured for execution by the one or more processors, the one or more programs including instructions for:
initializing a speech access server, including establishing one or more Transmission Control Protocol (TCP) long connections with each speech recognition server of a plurality of speech recognition servers;
receiving a speech request from a terminal;
determining, in accordance with a predefined load balancing algorithm, a first speech recognition server of the plurality of speech recognition servers to process the speech request;
determining whether the first speech recognition server is available for processing;
in accordance with a determination that the first speech recognition server is available, forwarding the speech request to the first speech recognition server for processing; and
in accordance with a determination that the first speech recognition server is not available:
determining, in succession, whether other speech recognition servers of the plurality of speech recognition servers, are available for processing; and
in accordance with a determination that a second speech recognition server is available, forwarding the speech request to the second speech recognition server for processing.

8. The computer system of claim 7, wherein the instruction for determining, in accordance with the predefined load balancing algorithm, the first speech recognition server includes instructions for:
obtaining a voice ID from the speech request;
generating a hash value based on the voice ID;
assigning a unique number to each speech recognition server of the plurality of speech recognition servers, wherein the plurality of speech recognition servers includes N speech recognition servers;
calculating a first value equal to the hash value modulo N; and
determining the first speech recognition server in accordance with a determination that the first value equals the unique number assigned to the first speech recognition server.

9. The computer system of claim 7, wherein the one or more programs further include instructions for:
determining whether the speech request was processed successfully by a respective speech recognition server;
in accordance with a determination that the speech request was processed successfully, returning a first message to the terminal; and
in accordance with a determination that the speech request was not processed successfully:
determining whether the respective speech recognition server is available for processing;
in accordance with a determination that the respective speech recognition server is available:
forwarding the speech request to the respective speech recognition server for processing;
determining whether the speech request was processed successfully by the respective speech recognition server;
in accordance with a determination that the speech request was processed successfully, returning the first message to the terminal; and
in accordance with a determination that the speech request was not processed successfully, returning a second message to the terminal; and
in accordance with a determination that the respective speech recognition server is not available, returning the second message to the terminal.

10. The computer system of claim 7, wherein the speech request is one of a plurality of speech requests associated with a speech information stream.

11. The computer system of claim 10, wherein the plurality of speech requests associated with the speech information stream are processed by the same speech recognition server of the plurality of speech recognition servers.

12. The computer system of claim 7, wherein the one or more programs further include instructions for recording which speech recognition servers of the plurality of speech recognition servers were not available for processing.

13. A non-transitory computer readable storage medium, storing one or more programs for execution by one or more processors of a computer system, the one or more programs including instructions for:
initializing a speech access server, including establishing one or more Transmission Control Protocol (TCP) long connections with each speech recognition server of a plurality of speech recognition servers;
receiving a speech request from a terminal;
determining, in accordance with a predefined load balancing algorithm, a first speech recognition server of the plurality of speech recognition servers to process the speech request;
determining whether the first speech recognition server is available for processing;
in accordance with a determination that the first speech recognition server is available, forwarding the speech request to the first speech recognition server for processing; and
in accordance with a determination that the first speech recognition server is not available:
determining, in succession, whether other speech recognition servers of the plurality of speech recognition servers, are available for processing; and
in accordance with a determination that a second speech recognition server is available, forwarding the speech request to the second speech recognition server for processing.

14. The non-transitory computer readable storage medium of claim 13, wherein the instruction for determining, in accordance with the predefined load balancing algorithm, the first speech recognition server includes instructions for:
obtaining a voice ID from the speech request;
generating a hash value based on the voice ID;
assigning a unique number to each speech recognition server of the plurality of speech recognition servers, wherein the plurality of speech recognition servers includes N speech recognition servers;
calculating a first value equal to the hash value modulo N; and
determining the first speech recognition server in accordance with a determination that the first value equals the unique number assigned to the first speech recognition server.

15. The non-transitory computer readable storage medium of claim 13, wherein the one or more programs further include instructions for:
determining whether the speech request was processed successfully by a respective speech recognition server;
in accordance with a determination that the speech request was processed successfully, returning a first message to the terminal; and
in accordance with a determination that the speech request was not processed successfully:
determining whether the respective speech recognition server is available for processing;
in accordance with a determination that the respective speech recognition server is available:
forwarding the speech request to the respective speech recognition server for processing;
determining whether the speech request was processed successfully by the respective speech recognition server;
in accordance with a determination that the speech request was processed successfully, returning the first message to the terminal; and
in accordance with a determination that the speech request was not processed successfully, returning a second message to the terminal; and
in accordance with a determination that the respective speech recognition server is not available, returning the second message to the terminal.

16. The non-transitory computer readable storage medium of claim 13, wherein the speech request is one of a plurality of speech requests associated with a speech information stream.

17. The non-transitory computer readable storage medium of claim 16, wherein the plurality of speech requests associated with the speech information stream are processed by the same speech recognition server of the plurality of speech recognition servers.

18. The non-transitory computer readable storage medium of claim 13, wherein the one or more programs further include instructions for recording which speech recognition servers of the plurality of speech recognition servers were not available for processing.
